(19) United States
(12) Patent Application Publication
(10) Pub. No.: US 2010/0264073 A1
(43) Pub. Date: Oct. 21, 2010

(54) Water-purifying device for increasing oxygen content

(76) Inventor: Min Chien Teng, Daya Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/078,534

(22) Filed: Apr. 1, 2008

(51) Int. Cl. C02F 1/72; B01D 35/157; B01F 3/04

(52) U.S. Cl. 210/136; 210/151; 210/137

(57) ABSTRACT

A water-purifying device for increasing oxygen content has at least one filter and a gas-liquid mixing device, and the gas-liquid mixing device comprises a pump and a spiral tube, wherein air enters the pump through a first gas inlet valve disposed at the front end of the pump and is mixed with the water source in a gas-liquid phase within the spiral tube to form a large amount of fine bubbles, thereby achieving the effect of increasing the oxygen content in water.

### BACKGROUND OF THE INVENTION

1. Field of the Invention

The present invention relates to a water-purifying device, and more particularly, to a water-purifying device, which can increase the oxygen content in water and enable the air dissolved in the water to form fine bubbles.

2. Description of the Prior Art:

A water-purifying device 9 of the prior art is shown in FIG. 8, which has a water inlet 91 and a water outlet 92. The water source to be filtered flows from the water inlet 91 to the water-purifying device 9. Then the filtered clean water source flows to and exits the water outlet 92 such that the users can drink the filtered clean water directly, or drink after the water is boiled.

In general, the foregoing water-purifying device 9 just simply filters out the impurities in water but cannot further increase the oxygen content in water. Therefore, how to increase the oxygen content in water and increase the oxygen content in human after drinking the water over a long period of time is the problem that the present invention has been made to solve.

### SUMMARY OF THE INVENTION

The primary objective of the present invention that has been made to solve the aforementioned problem is to provide a water-purifying device for increasing oxygen content, which improves the conventional water-purifying device, and can filter out the impurities in water, as well as can increase the oxygen content in the water, advantageous to human absorption and metabolism.

To achieve the above objective, the present invention provides a water-purifying device for increasing oxygen content, which has at least one filter and a gas-liquid mixing device, wherein the filter has a first water inlet and a first water outlet and the gas-liquid mixing device comprises:

a pump which has s a second water inlet and a second water outlet, and the second water inlet communicates with the first water outlet, and at least a first gas inlet valve is disposed between the second water inlet and the first water outlet, and the second water outlet communicates with a water supply channel, and air is introduced by means of the first gas inlet valve and enters the pump such that the pump pressurizes the air and the water source for gas-liquid mixing and then transports the gas-liquid mixture from the second water outlet to the water supply channel; and

a spiral tube which communicates with the water supply channel such that the gas-liquid mixed water source contained in the water supply channel flows into the spiral tube for gas-liquid mixing once again allowing the air and the water source to swirl and mix within the spiral tube, and the oxygen-rich water source is transported from the spiral tube.

Moreover, according to the present invention, a regulating valve can be additionally disposed in the water supply channel to regulate the water flow capacity from the water supply channel to the spiral tube and simultaneously regulate the outlet water pressure from the water supply channel to the spiral tube.

In addition, the water supply channel can be additionally provided there in with a pressurized water storage tank for storing the water source which has undergone the first gas-liquid mixing through the pump, and the pressurized water storage tank builds up the pressure to pressurize the water source for the second time when transported from the pressurized water storage tank.

Also, the water supply channel can be provided therein with at least one horizontal filter and the spiral tube is placed within the horizontal filter, and the both ends of the spiral tube are respectively connected with a third water inlet and a third water outlet disposed at the horizontal filter so as to obtain the oxygen-rich water source.

Furthermore, according to the pre sent invention, the gas-liquid mixing device is further provided with a gas-liquid mixing tank, and the gas-liquid mixing tank is provided with a gate valve seat to form an enclosed space within the gas-liquid mixing tank and the spiral tube is disposed in the enclosed space, and the gate valve seat has a water inlet portion and a water outlet portion, and the water inlet portion communicates with the water supply channel and the spiral tube. The spiral tube is further provided with a high-pressure water outlet to eject the second gas-liquid mixed water source from the high-pressure water outlet and perform the third gas-liquid mixing in the enclosed space.

Besides, the gas-liquid mixing tank is further provided with a second gas inlet valve, and air is introduced by means of the second gas inlet valve for the second time and perform the fourth gas-liquid mixing in the enclosed space.

There are a plurality of granular filter units arranged in the foregoing gas-liquid mixing tank to filter the water source in the gas-liquid mixing tank for the second time, and the filter units collide and squeeze with one another to allow more durable and homogeneous gas-liquid mixing, thus increasing the oxygen content in the water.

### BRIEF DESCRIPTION OF THE DRAWINGS

FIG. 1 is a schematic view showing a structure according to a first embodiment of the present invention.

FIG. 2 is a schematic view showing a structure according to a second embodiment of the present invention.

FIG. 3 is a schematic view showing a structure according to a third embodiment of the present invention.

FIG. 4 is a schematic view showing a structure according to a fourth embodiment of the present invention.

FIG. 5 is a schematic view showing a structure according to a fifth embodiment of the present invention.

FIG. 6 is a schematic view showing a structure according to a sixth embodiment of the present invention.

FIG. 7 is a schematic view showing a service condition according to a sixth embodiment of the present invention.

FIG. 8 is a water-purifying device of the prior art.

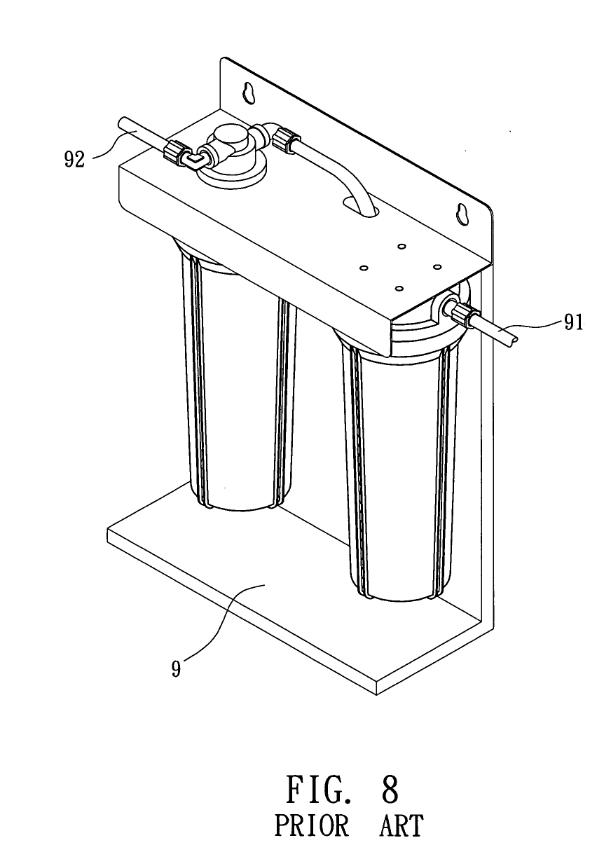

### DETAILED DESCRIPTION OF THE PREFERRED EMBODIMENTS

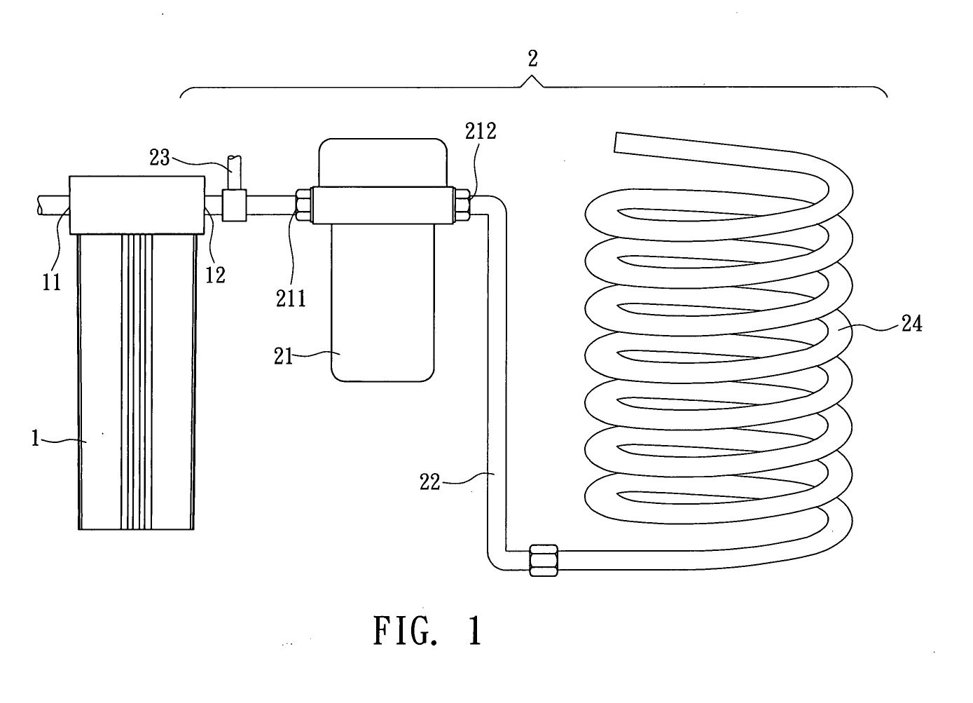

Referring to FIGS. 1 to 7, the structures according to the embodiments of the present invention are shown in these drawings, which are only illustrative and not intended to limit the scope of the present invention.

Referring to FIG. 1, there is a water-purifying device for increasing oxygen content shown, which has at least one filter 1 and a gas-liquid mixing device 2, wherein the filter 1 has a first water inlet 11 and a first water outlet 12, and the filter 1 is equipped therein with a filter element (not shown), and the gas-liquid mixing device 2 comprises:

A pump 21 which has a second water inlet 211 and a second water outlet 212, and the second water inlet 211 communicates with the first water outlet 12, and at least a first gas inlet valve 23 is disposed between the second water inlet 211 and the first water outlet 12, and the second water outlet 212 communicates with a water supply channel 22, and air is introduced by means of the first gas inlet valve 23 and enters the pump 21 such that the pump 21 pressurizes the air and the water source to perform the gas-liquid mixing for the first time and to generate a lot of fine oxygen-containing bubbles in the water source. After that, the water source containing many fine bubbles is transported from the second water outlet 212 to the water supply channel 22. In this embodiment, the pump 21 is, for example, a high-pressure pump, and the first gas inlet valve 23 is a check valve to prevent the backflow of the water source and allow it to flow from the first gas inlet valve 23.

A spiral tube 24 which communicates with the water supply channel 22 and the water supply channel 22 contains the first gas-liquid mixed water source so that the water source flows into the spiral tube 24 and is subjected to the second gas-liquid mixing in the spiral tube 24. Since the air and the water source swirl and mix within the spiral tube 24, the air can be mixed into the water more homogeneously, and the oxygen-rich water source can be transported from the spiral tube 24.

In view of the above, the combination of the spiral tube 24, the pump 21 and the first gas inlet valve 23 in this embodiment can achieve the effect of increasing the oxygen content in water.

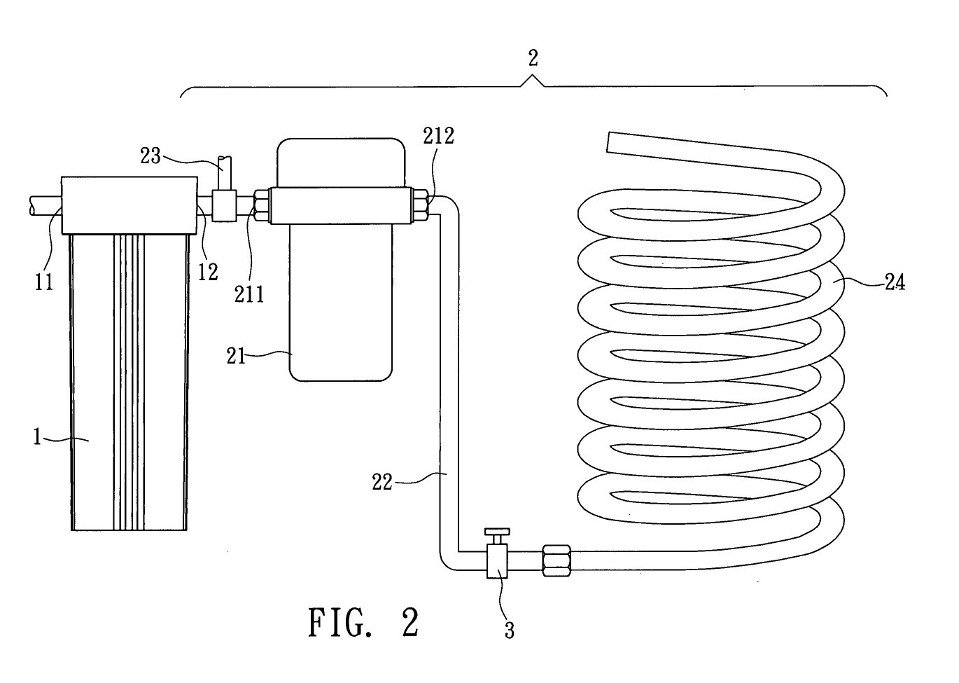

It is understood that the present invention still has other variants those are only different from some changes. Referring to FIG. 2, a second embodiment of the present invention is shown, wherein a regulating valve 3 is additionally disposed in the water supply channel 22 to regulate the water flow capacity from the water supply channel 22 to the spiral tube 24 and simultaneously regulate the outlet water pressure from the water supply channel 22 to the spiral tube 24. In this embodiment, the regulating valve 3 is a flow-limiting valve.

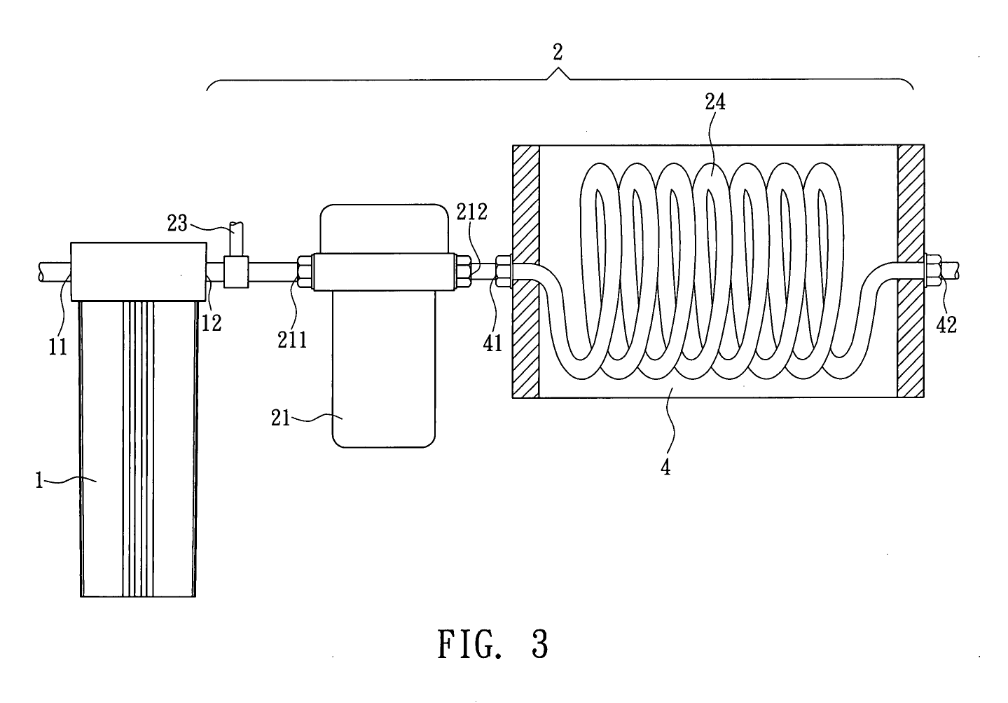

Referring to FIG. 3, a third embodiment of the present invention is shown, wherein the water supply channel 22 is provided therein with at least one horizontal filter 4 and the spiral tube 24 is placed within the horizontal filter 4, and the both ends of the spiral tube 24 are respectively connected with a third water inlet 41 and a third water outlet 42 disposed at the horizontal filter 4 so as to obtain the oxygen-rich water source.

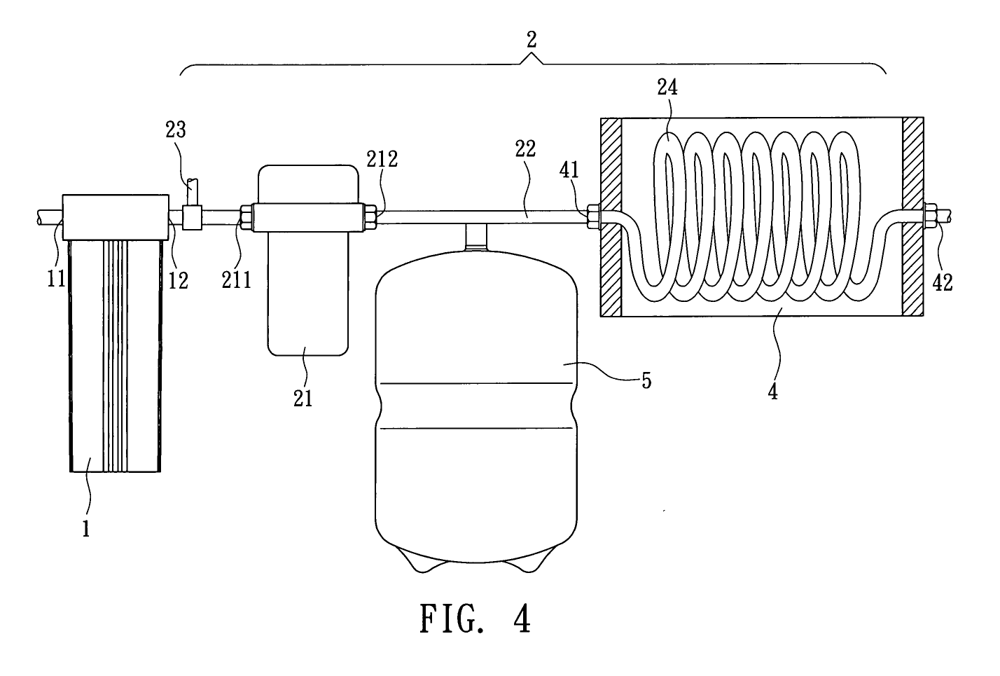

Referring to FIG. 4, a fourth embodiment of the present invention is shown, wherein the water supply channel 22 is additionally provided therein with a pressurized water storage tank 5 for storing the water source which has undergone the first gas-liquid mixing through the pump 21, and the pressurized water storage tank 5 builds up the pressure to pressurize the water source for the second time when transported from the pressurized water storage tank 5.

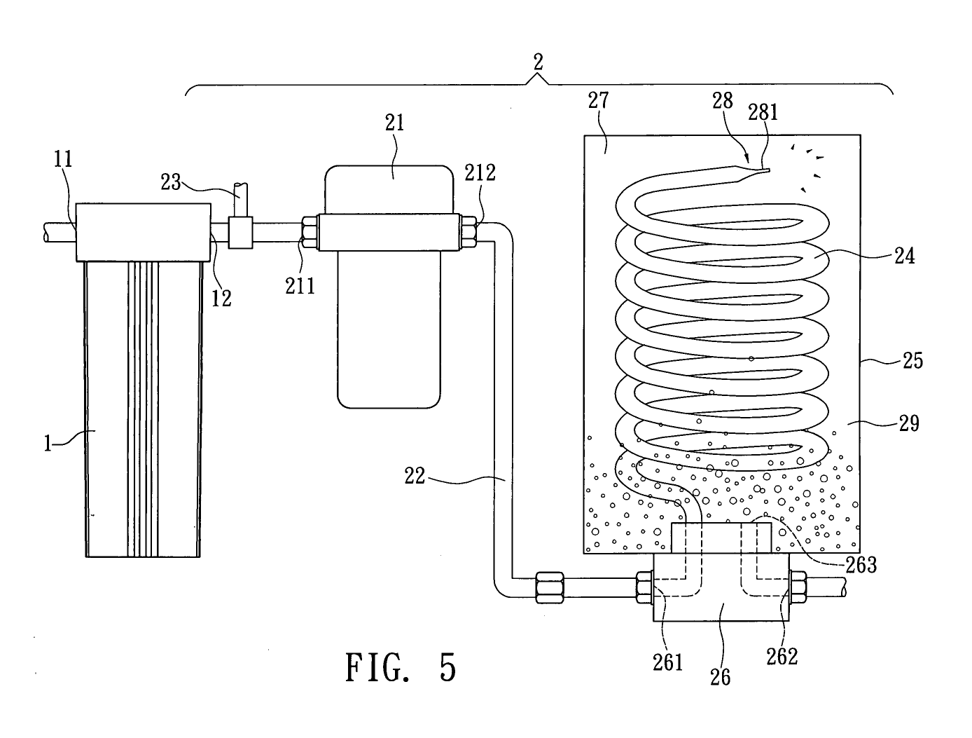

Referring to FIG. 5, a fifth embodiment of the present invention is shown, wherein the gas-liquid mixing device 2 is further provided with a gas-liquid mixing tank 25. The gas-liquid mixing tank 25 is provided at the bottom thereof with a gate valve seat 26 to form an enclosed space 27 within the gas-liquid mixing tank 25 and the spiral tube 24 is disposed in the enclosed space 27. In this embodiment, one end of the spiral tube 24 is disposed on the gate valve seat 26, and the gate valve seat 26 has a water inlet portion 261 and a water outlet portion 262, and the water inlet portion 261 communicates with the water supply channel 22 and the spiral tube 24 disposed on the gate valve seat 26. The water outlet portion 262 has a diversion hole 263 which communicates with the enclosed space 27 of the gas-liquid mixing tank 25.

The spiral tube 24 further comprises a high-pressure water outlet 28, and the high-pressure water outlet 28 has a flat open end 281 to deliver the water source as mentioned in the above embodiments from the open end 281 of the high-pressure water outlet 28 after gas-liquid mixing in the spiral tube 24.

The open end 281 of the high-pressure water outlet 28 is flat-shaped so that the flow channel is convergent. Therefore, when the water source flows to the open end 281, the pressure will increase. This results in that the water stream is ejected from the high-pressure water outlet 28 in the form of high-pressure spray and impacts on the one side of the enclosed space 27 of the gas-liquid mixing tank 25. In this embodiment, the high-pressure water outlet 28 corresponds to one side of the head of the gas-liquid mixing tank 25.

Furthermore, water molecules would change their direction of movement while colliding with the gas-liquid mixing tank 25 so that the direction of the high-pressure water stream impacting on the gas-liquid mixing tank 25 will be changed and turbulent flows will occur in the gas-liquid mixing tank 25 to advantageously perform the third gas-liquid mixing. Numerous finer bubbles will form in the water source after the gas-liquid mixing.

Additionally, in order to improve the effects of water purification and gas-liquid mixing, a plurality of granular filter units 29 are placed into the gas-liquid mixing tank 25 to filter the water source in the gas-liquid mixing tank 25 once again, and the filter units 29 collide and squeeze with one another to allow more durable and homogeneous gas-liquid mixing, thus increasing the oxygen content in the water.

The foregoing gas-liquid mixed water source for three times has contained a large amount of fine bubbles, that is, a large amount of air has been mixed into the water source and increases the oxygen content in the water so that the water source can be guided by the diversion hole 263 of the gate valve seat 26 to the water outlet portion 262 and be drained.

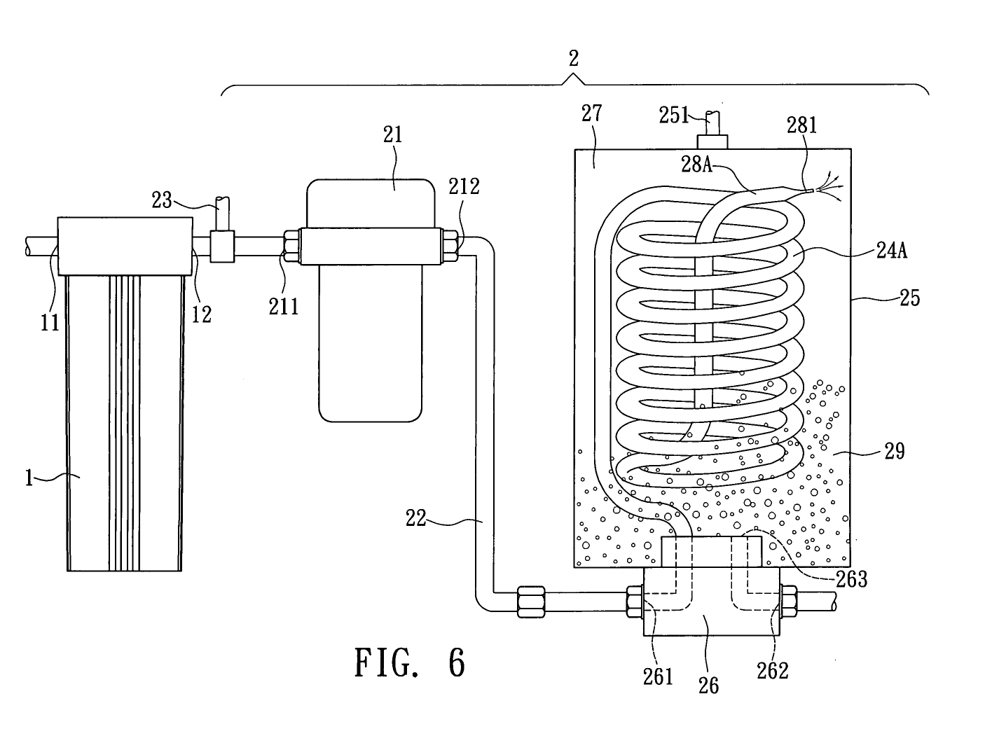

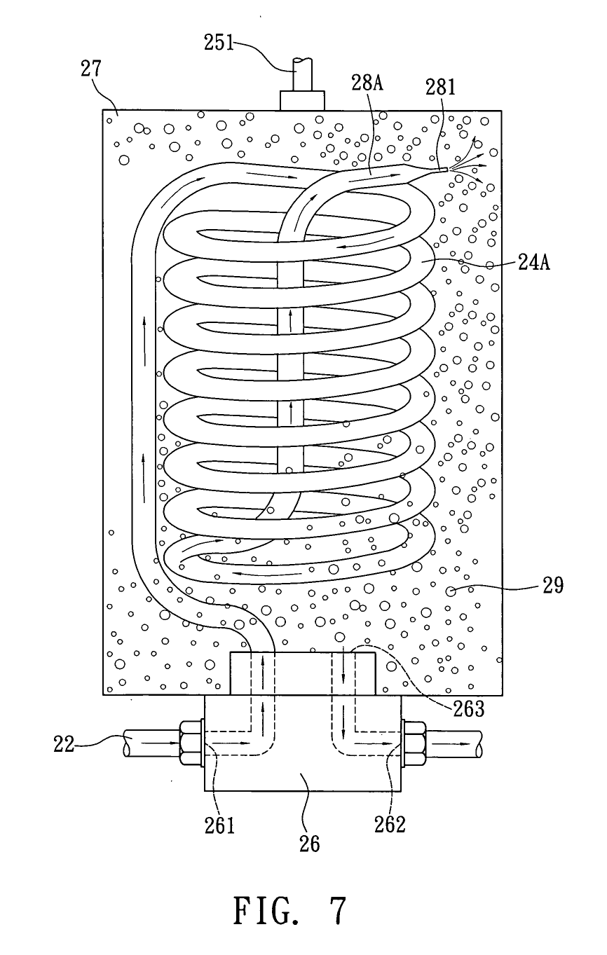

Next, referring to FIGS. 6 and 7, a sixth embodiment of the present invention is shown, which differs from the foregoing fifth embodiment in that the high-pressure water outlet 28A passes through out of the region surrounded by the spiral tube 24A, and the gas-liquid mixing tank 25 is further provided with at least a second gas inlet valve 251. In this embodiment, a check valve is taken for an example of the second gas inlet valve 251. Air is introduced by means of the second gas inlet valve 251 for the second time and undergoes the fourth gas-liquid mixing in the enclosed space 27. The oxygen content in water would be further increased by the introduction of more air through the second gas inlet valve 251.

From the above embodiments, the advantages of the present invention are as follows: air and a water source simultaneously enter the pump, and the pump pressurizes the air and the water source for mixing and enables the pressurized gas-liquid mixture to enter a spiral tube for gas-liquid mixing once again and then to pass through a high-pressure water outlet and to be ejected into the gas-liquid mixing tank in the form of high-pressure water stream. The arrangement of the filter units in coordination with the first and second gas inlet valves can allow the air and the water source to mix more homogeneously. Not only does the oxygen content in water significantly increase, but also the mixed water source contains a large amount of fine bubbles, thereby enhancing human absorption.

Moreover, if the present invention is applied to aquariums, aquafarms or the related aquiculture, due to the increased oxygen content in water, there is no need for the arrangement of large ventilators to pump air in. Therefore, the additional space required for the installation of the large ventilators can be reduced in addition to the lowered manufacturing costs.

I claim:

1. A water-purifying device for increasing oxygen content, which has at least one filter and a gas-liquid mixing device, wherein the filter has a first water inlet and a first water outlet and the gas-liquid mixing device comprises:
a pump which has a second water inlet and a second water outlet, and the second water inlet communicates with the first water outlet, and at least a first gas inlet valve is disposed between the second water inlet and the first water outlet, and the second water outlet communicates with a water supply channel, and air is introduced by means of the first gas inlet valve and enters the pump such that the pump pressurizes the air and the water source for gas-liquid mixing and then transports the gas-liquid mixture from the second water outlet to the water supply channel; and
a spiral tube which communicates with the water supply channel such that the gas-liquid mixed water source contained in the water supply channel flows into the spiral tube for gas-liquid mixing once again allowing the air and the water source to swirl and mix within the spiral tube, and the oxygen-rich water source is transported from the spiral tube.

2. The water-purifying device for increasing oxygen content as claimed in claim 1, wherein the pump is a high-pressure pump.

3. The water-purifying device for increasing oxygen content as claimed in claim 1, wherein the first gas inlet valve is a check valve.

4. The water-purifying device for increasing oxygen content as claimed in claim 1, wherein a regulating valve is additionally disposed in the water supply channel to regulate the water flow capacity from the water supply channel to the spiral tube and simultaneously regulate the outlet water pressure from the water supply channel to the spiral tube.

5. The water-purifying device for increasing oxygen content as claimed in claim 4, wherein the regulating valve is a flow-limiting valve.

6. The water-purifying device for increasing oxygen content as claimed in claim 1, wherein the water supply channel is additionally provided therein with a pressurized water storage tank for storing the water source which has undergone the first gas-liquid mixing through the pump, and the pressurized water storage tank builds up the pressure to pressurize the water source for the second time when transported from the pressurized water storage tank.

7. The water-purifying device for increasing oxygen content as claimed in claim 1, wherein the water supply channel is provided therein with at least one horizontal filter and the spiral tube is placed within the horizontal filter, and the both ends of the spiral tube are respectively connected with a third water inlet and a third water outlet disposed at the horizontal filter.

8. The water-purifying device for increasing oxygen content as claimed in claim 1, wherein the gas-liquid mixing device is further provided with a gas-liquid mixing tank, which is provided with a gate valve seat to form an enclosed space within the gas-liquid mixing tank and the spiral tube is disposed in the enclosed space, and the gate valve seat has a water inlet portion and a water outlet portion, and the water inlet portion communicates with the water supply channel and the spiral tube.

9. The water-purifying device for increasing oxygen content as claimed in claim 8, wherein the gate valve seat is disposed on the bottom of the gas-liquid mixing tank.

10. The water-purifying device for increasing oxygen content as claimed in claim 8, wherein one end of the spiral tube is disposed on the gate valve seat.

11. The water-purifying device for increasing oxygen content as claimed in claim 8, wherein the gate valve seat has a diversion hole which communicates with the enclosed space of the gas-liquid mixing tank.

12. The water-purifying device for increasing oxygen content as claimed in claim 1, wherein the spiral tube further comprises a high-pressure water outlet, and the high-pressure water outlet has a flat open end to deliver the water source from the open end of the high-pressure water outlet of the spiral tube.

13. The water-purifying device for increasing oxygen content as claimed in claim 8, wherein the spiral tube further comprises a high-pressure water outlet, and the high-pressure water outlet has a flat open end to deliver the water source from the open end of the high-pressure water outlet of the spiral tube.

14. The water-purifying device for increasing oxygen content as claimed in claim 13, wherein the high-pressure water outlet corresponds to one side of the head of the gas-liquid mixing tank.

15. The water-purifying device for increasing oxygen content as claimed in claim 8, wherein the gas-liquid mixing tank is further provided with at least a second gas inlet valve, and air is introduced by means of the second gas inlet valve for the second time and undergoes the gas-liquid mixing in the enclosed space.

16. The water-purifying device for increasing oxygen content as claimed in claim 15, wherein the second gas inlet valve is a check valve.

17. The water-purifying device for increasing oxygen content as claimed in claim 8, wherein a plurality of granular filter units are placed into the gas-liquid mixing tank to filter the water source in the gas-liquid mixing tank once again, and the filter units collide and squeeze with one another to allow more durable and homogeneous gas-liquid mixing, thus increasing the oxygen content in water.
